(19) United States
(12) Patent Application Publication
(10) Pub. No.: US 2024/0394103 A1
(43) Pub. Date: Nov. 28, 2024

(54) SECURE ALLOCATED RESOURCE TRACKING METHOD FOR OPTIMIZING MULTIPLE OPERATIONS

(71) Applicant: Bank of America Corporation, Charlotte, NC (US)

(72) Inventor: Timucin Ozugur, Fairview, TX (US)

(21) Appl. No.: 18/200,767

(22) Filed: May 23, 2023

(51) Int. Cl. G06F 9/50

(52) U.S. Cl. CPC G06F 9/5027

(57) ABSTRACT

Aspects of the disclosure relate to an operation optimization platform for optimizing multiple operations using a secure allocated resource tracking method. The platform may configure project silos corresponding to an operation. The platform may generate project tags based on the project silos. The platform may execute at least one performance of the operation. The platform may generate a record of applications performing the operation. The platform may receive a request to access the record of applications. The request may include authentication information and a request tag identifying the requested information. The platform may determine whether to grant access to the record. The platform may send a portion of the record based on determining to grant access. The platform may input the record into an operation optimization model trained by the platform to output project management rules. The platform may optimize project management by modifying a project management ruleset.

### BACKGROUND

Aspects of the disclosure relate to optimizing multiple operations using a secure allocated resource tracking method. In some instances, a system may manage multiple operations (e.g., cybersecurity operations, and/or other operations), where each operation is executed using a specific set of resources (e.g., applications, and/or other resources). Execution of an operation may be performed as part of a project. The project may be created automatically, or manually by a user (e.g., an employee of an enterprise organization, such as a financial institution, and/or other organizations). Multiple projects may be created such that distinct projects exist for respective instances of executing the operation. In some instances, two or more of these projects may use the same, or some of the same, resources to execute the same operation. Accordingly, it may be important to improve the efficiency of project creation. In some instances, however, such information may include cybersecurity information and/or other sensitive information. In these instances, it may also be important to restrict access to the information. Accordingly, it may be important to improve project efficiency while balancing information security.

### SUMMARY

Aspects of the disclosure provide effective, efficient, scalable, and convenient technical solutions that address and overcome the technical problems associated with optimizing multiple operations. In accordance with one or more arrangements of the disclosure, a computing platform with at least one processor, a communication interface, and memory storing computer-readable instructions may configure a plurality of project silos corresponding to a first operation performed using a first set of information based on a project management ruleset. The computing platform may generate a plurality of project tags based on the plurality of project silos. Each project tag may correspond to a different project silo. A given project tag may comprise operation-level information corresponding to the first operation, project-level information of the corresponding project silo, and application-level information corresponding to at least one application included in the project silo. The computing platform may execute at least one performance of the first operation using the first set of information. The computing platform may generate a record of applications performing the first operation and using the first set of information based on the application-level information of each project tag. The computing platform may receive a first request to access the record of applications from a first user device corresponding to a first user. The first request may comprise authentication information corresponding to the first user and a first request tag. The first request tag may comprise at least one of: a selection of requested operation-level information, a selection of requested project-level information, and a selection of requested application-level information. The computing platform may determine whether or not to grant the first user device access to the record of applications based on comparing the authentication information to a list of permissions associated with the record of applications. The computing platform may send a first portion of the record of applications to the first user device based on determining to grant the first user device access to the record of applications. The first portion of the record of applications may correspond to the first request tag. The computing platform may input the record of applications into an operation optimization model. Inputting the record of applications into the operation optimization model may cause the operation optimization model to output one or more project management rules. The computing platform may modify the project management ruleset based on the one or more project management rules. Modifying the project management ruleset may produce a modified project management ruleset.

In one or more examples, the computing platform may receive a second request to access the record of applications from a second user device corresponding to a second user. The second request may comprise application-level authentication information and a second request tag. The second request tag may comprise at least one of: a selection of requested operation-level information, a selection of requested project-level information, and a selection of requested application-level information. The computing platform may determine whether or not to grant the second user device access to the record of applications based on comparing the application-level authentication information to a list of permissions associated with the record of applications. The computing platform may send a second portion of the record of applications to the second user device, based on determining to grant the second user device access to the record of applications. The second portion of the record of applications may correspond to the second request tag.

In one or more instances, the computing platform may train the operation optimization model to output the one or more project management rules based on input of a given record of applications prior to inputting the record of applications and based on the project management ruleset. The computing platform may update the operation optimization model based on the modified project management ruleset. Updating the operation optimization model may cause the operation optimization model to perform one or more of: output a rule for merging project silos based on input of a record of applications indicating at least two project silos include a same portion of application-level information, output a rule for creating project silos based on input of a record of applications indicating at least two project silos include a same portion of application-level information, or output a rule for removing project silos based on input of a record of applications indicating at least two project silos include a same portion of application-level information.

In one or more examples, a given project silo, of the plurality of project silos, may comprise a project name identifier, a project tag identifier, a list of permissions limiting access to the project silo, a list of applications used to perform the first operation, and at least a portion of the first set of information. In one or more instances, configuring the plurality of project silos corresponding to the first operation may be performed by the operation optimization model. In one or more examples, configuring the plurality of project silos corresponding to the first operation may be performed based on user input.

In one or more instances, modifying the project management ruleset may comprise at least one of: adding a rule, of the one or more project management rules, for creating project silos; adding a rule, of the one or more project management rules, for merging project silos; adding a rule, of the one or more project management rules, for removing project silos; merging a rule, of the one or more project management rules, with an existing rule; or modifying, based on the one or more project management rules, access permissions for one or more project silos. In one or more examples, the computing platform may cause the first user device to display a notification interface based on determining not to grant the first user device access to the record of applications. The notification interface may indicate the first user is not authorized to access the record of applications. The computing platform may send a project management update to the first user device based on the modifying. The project management update may comprise the modified project management ruleset.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for a secure allocated resource tracking method for optimizing multiple operations in accordance with one or more example arrangements;

FIGS. 2A-2D depict an illustrative event sequence for a secure allocated resource tracking method for optimizing multiple operations in accordance with one or more example arrangements;

FIGS. 3A-3B depict illustrative project tags used in a secure allocated resource tracking method for optimizing multiple operations in accordance with one or more example arrangements;

FIGS. 4A-4D depict illustrative graphical user interfaces depicting a secure allocated resource tracking method for optimizing multiple operations in accordance with one or more example arrangements; and

FIGS. 5A-5B depict an illustrative method for a secure allocated resource tracking method for optimizing multiple operations in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to a secure allocated resource tracking method for optimizing multiple operations. Enterprise organizations (e.g., such as a financial institution and/or other institutions) may employ a cybersecurity system with separate operations (e.g., a secure-by-design operation model (SbD), a self-service operation model, and/or other operations). Each operation may have its own metrics and be governed separately by the overall cybersecurity system. Each operation may also be executed using a specific set of resources (e.g., applications, sets of information, and/or other resources). However, in some instances, some of these operations may be executed multiple times within a specific time period using different sets of resources and/or may be triggered by different conditions (e.g., user input, automatic execution, and/or other conditions). In these instances, some or all resources used in one instance of executing the operation may be used again in another instance, resulting in an inefficient allocation of resources.

For example, to execute an operation, a project may be created within the cybersecurity system managed by the enterprise organization. The project may identify the operation to be executed and the resources to be used when executing the operation in a specific instance. For example, the project may identify a specific application used to execute the operation. Multiple additional projects may be created (e.g., automatically created by a machine learning model, manually created by a user, and/or created by other methods), some of which, e.g., use the same application to execute the operation. Overall, this system may lead to inefficiencies in resource allocation in situations where two or more projects could be combined (e.g., executed at the same time rather than as separate instances). There exists a strong need to develop a method of tracking resource allocation across multiple operations to optimize execution of the operations. Additionally, in some examples, various security measures (e.g., authorization codes, authentication information, and/or other security measures) may control access to information of the allocation of resources between operations and/or projects. In these examples, there also exists a need to ensure that any new method of tracking resource allocation across multiple operations to optimize execution of the operations is configured to work within a secure system. Accordingly, a system may use multi-layer tagging, based on several parameters (e.g., operation-level information, project-level information, application-level information, and/or other parameters) to track resource allocation across multiple projects for one or more operations, in order to determine how the operations may best be optimized.

Enterprise organizations may employ the system described above by, for a given operation, configuring a plurality of project silos, where a given project silo contains the operation-level information, project-level information, and application-level information for a specific project. In some instances, the system may generate a project tag for each project silo, where the project tags can be used by users (e.g., administrative employees of the enterprise organization, software developer employees of the enterprise organization, and/or other users). In some examples, after the operation has been executed as part of at least one project, the system may generate and then maintain a record of the applications used to execute the operation across multiple projects (e.g., by aggregating the application-level information of each project silo). In these examples, a user (e.g., an employee of the enterprise organization, and/or other users) may wish to access some portion of the record (e.g., to view the results of a project, to view operational-level information to optimize project management, and/or for other reasons). Accordingly, the user may send a request tag that corresponds to the operation-level information, project-level information, and/or application-level information of one or more project silos configured by the system, requesting access to a portion of the record. The system may, based on security information (e.g., permissions lists, authentication information, authorization codes, passwords, encryption keys, and/or other security information) grant the user access to the portion of the record based on the request tag.

For example, in some instances, the user may only have access to application-level information of a particular project silo. If the user requests access to other information, the system may deny access. Additionally or alternatively, in some instances the user may have access to operation-level information across all project silos (e.g., if the user is an administrative employee of the enterprise organization, and/or other user with authorization to optimize operations). In these instances, the user may have requested, and be granted access to, all of the operation-level information across all project silos. For example, the user may be able to view which applications have been used repeatedly in different project silos to perform the same operation. In these instances, the user may use this information to optimize the operation. For instance, the user may modify a project management ruleset providing instructions on project creation and/or management (e.g. rules governing the frequency of new projects, rules governing which applications to use in new projects, rules combining projects that use the same application-level information, and/or other rules). In some instances, the user may modify the project management ruleset by inputting the record into a machine learning model (e.g., an operation optimization model, and/or other models) to output new project management rules, and modify the project management ruleset accordingly.

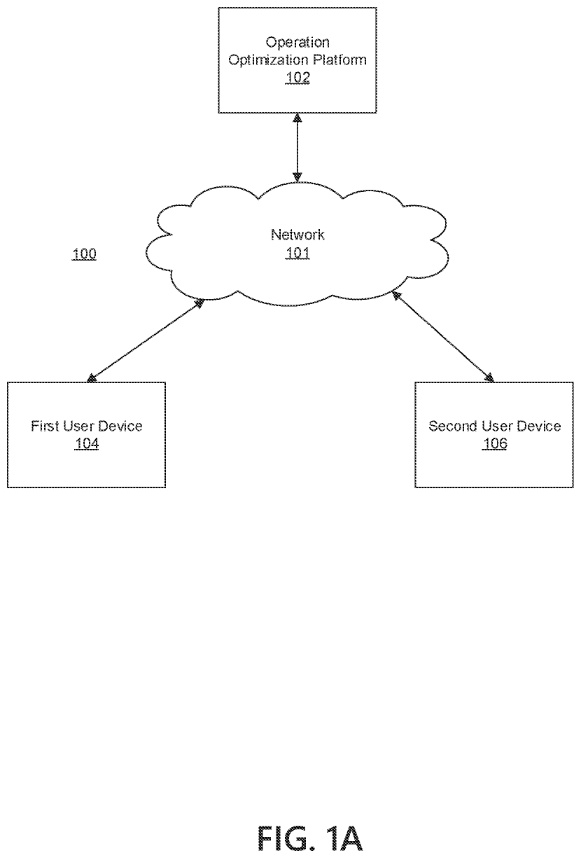

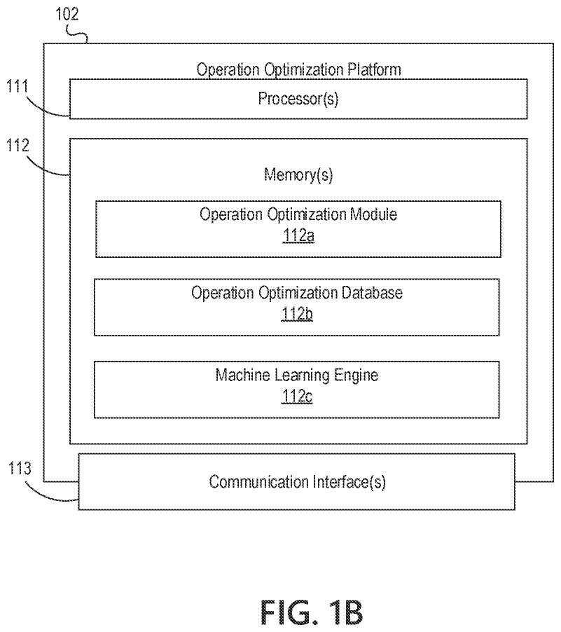

FIGS. 1A-1B depict an illustrative computing environment for a secure allocated resource tracking method for optimizing multiple operations in accordance with one or more example arrangements. Referring to FIG. 1A, computing environment 100 may include one or more computer systems. For example, computing environment 100 may include an operation optimization platform 102, a first user device 104, and a second user device 106. In some instances, first user device 104 and second user device 106 may be the same user device.

As described further below, operation optimization platform 102 may be a computer system that includes one or more computing devices (e.g., servers, server blades, or the like) and/or other computer components (e.g., processors, memories, communication interfaces) that may be used to configure, train and/or execute one or more machine learning models (e.g., an operation optimization model, and/or other models). For example, the operation optimization platform 102 may train the one or more machine learning models to output project management rules based on records of applications used to execute an operation. In some instances, operation optimization platform 102 may be controlled or otherwise maintained by an enterprise organization (e.g., a financial institution, and/or other institutions). Although shown as an independent computing platform, in some instances, the operation optimization platform 102 may be part of and/or otherwise integrated into the first user device 104 and/or second user device 106 without departing from the scope of the disclosure.

First user device 104 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer data between users and/or perform other user functions (e.g., requesting user input, providing a proposed password, and/or other functions). In one or more instances, first user device 104 may correspond to a first user (who may, e.g., be an employee or client of the enterprise organization, such as a financial institution and/or other institution). In one or more instances, the first user device 104 may be configured to communicate with one or more systems (e.g., operation optimization platform 102 and/or other systems) to perform a data transfer, request access to a record, and/or to perform other functions. In some instances, the first user device 104 may be configured to display one or more graphical user interfaces (e.g., application-level information interfaces, access notification interfaces, record of application interfaces, and/or other interfaces).

Second user device 106 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer data between users and/or perform other user functions (e.g., requesting user input, providing a proposed password, and/or other functions). In one or more instances, second user device 106 may correspond to a second user (who may, e.g., be an employee or client of the enterprise organization, such as a financial institution and/or other institution). In some instances, the second user may be the same as the first user. In one or more instances, the second user device 106 may be configured to communicate with one or more systems (e.g., operation optimization platform 102 and/or other systems) to perform a data transfer, request access to a record, and/or to perform other functions. In some instances, the second user device 106 may be configured to display one or more graphical user interfaces (e.g., application-level information interfaces, access notification interfaces, record of application interfaces, and/or other interfaces). In some instances, the second user device 106 may be the same device as first user device 104. Additionally or alternatively, in some instances the first user device 104 and the second user device 106 may be associated with users having different levels of authorization. For example, the first user device 104 may be associated with a user who only has authorization to access application-level information (e.g., as described below at steps 206-208). In some examples, the second user device 106 may be associated with a user who has authorization to access operation-level information and all subordinate information in a hierarchy (e.g., as described below at steps 209-211).

Computing environment 100 also may include one or more networks, which may interconnect operation optimization platform 102, first user device 104, and second user device 106. For example, computing environment 100 may include a network 101 (which may interconnect, e.g., operation optimization platform 102, first user device 104, and second user device 106). In some instances, the network 101 may include network traffic information (e.g., information corresponding to authentication attempts, and/or other information) between one or more devices connected via the network 101.

In one or more arrangements, operation optimization platform 102, first user device 104, and second user device 106 may be any type of computing device capable of sending and/or receiving requests and processing the requests accordingly. For example, operation optimization platform 102, first user device 104, second user device 106 and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of operation optimization platform 102, first user device 104, and second user device 106 may, in some instances, be special-purpose computing devices configured to perform specific functions.

Referring to FIG. 1B, operation optimization platform 102 may include one or more processors 111, memory 112, and communication interface 113. A data bus may interconnect processor 111, memory 112, and communication interface 113. Communication interface 113 may be a network interface configured to support communication between operation optimization platform 102 and one or more networks (e.g., network 101, or the like). Communication interface 113 may be communicatively coupled to the processor 111. Memory 112 may include one or more program modules having instructions that, when executed by processor 111, cause operation optimization platform 102 to perform one or more functions described herein and/or one or more databases that may store and/or otherwise maintain information which may be used by such program modules and/or processor 111. In some instances, the one or more program modules and/or databases may be stored by and/or maintained in different memory units of operation optimization platform 102 and/or by different computing devices that may form and/or otherwise make up operation optimization platform 102. For example, memory 112 may have, host, store, and/or include operation optimization module 112a, operation optimization database 112b, and machine learning engine 112c.

Operation optimization module 112a may have instructions that direct and/or cause operation optimization platform 102 to optimize multiple operations using a secure allocated resource tracking method. Operation optimization database 112b may have instructions causing operation optimization platform 102 to store project tags and/or project silos (that may, e.g., be used to optimize multiple operations using a secure allocated resource tracking method). Machine learning engine 112c may contain instructions causing operation optimization platform 102 to train, implement, and/or update a machine learning model, such as an operation optimization model, (that may, e.g., be used to optimize multiple operations using a secure allocated resource tracking method). In some instances, machine learning engine 112c may be used by operation optimization platform 102 and/or operation optimization module 112a to refine and/or otherwise update methods for optimizing multiple operations using a secure allocated resource tracking method, and/or other methods described herein.

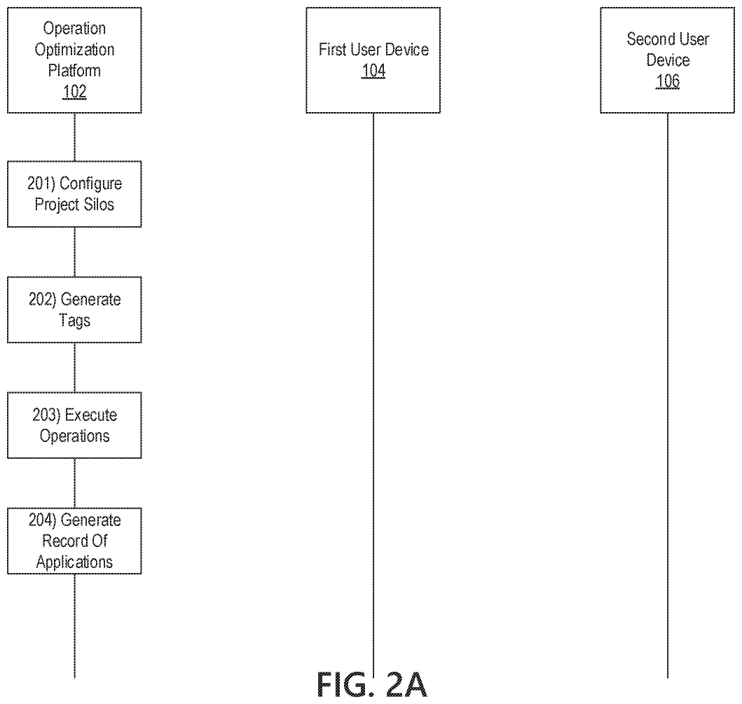

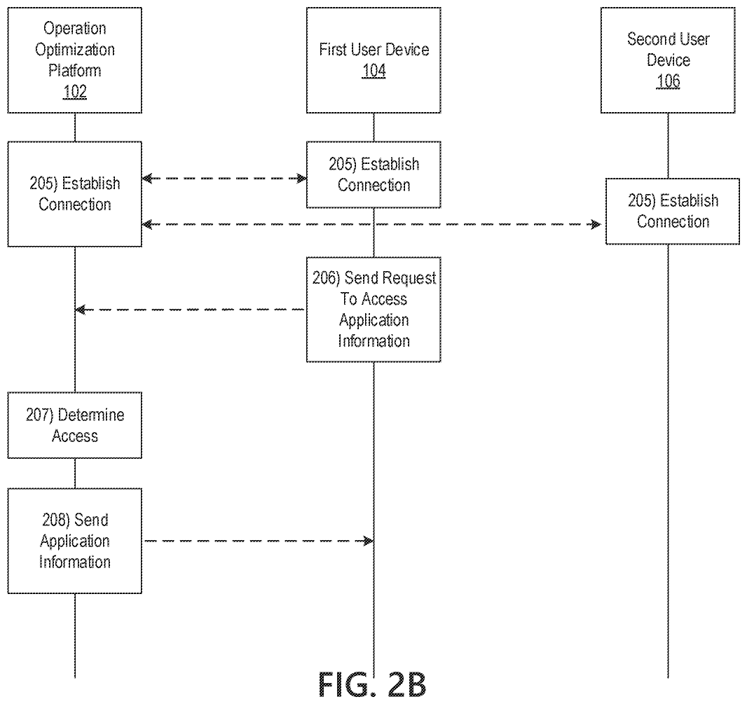

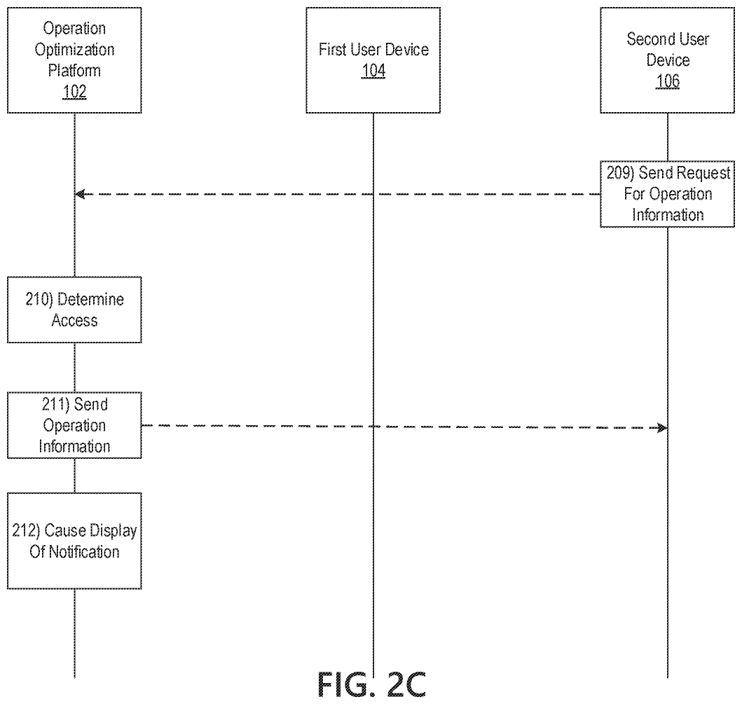

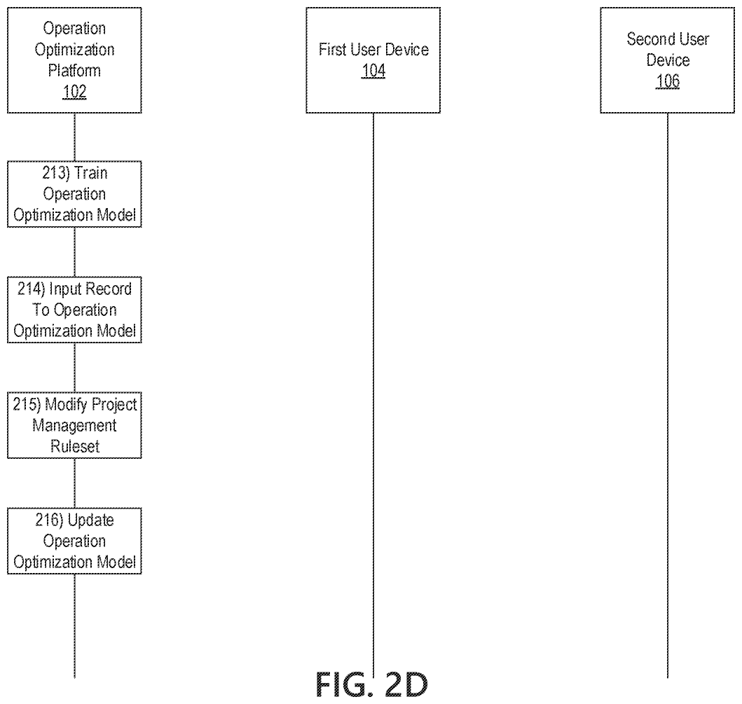

FIGS. 2A-2D depict an illustrative event sequence for a secure allocated resource tracking method for optimizing multiple operations in accordance with one or more example arrangements. Referring to FIG. 2A, at step 201, the operation optimization platform 102 may configure a plurality of project silos. A project silo may be and/or include a record, corresponding to a specific project, and may include information indicating the operation the project was created to perform, information indicating one or more applications used by the project to execute the operation, and/or other information. In configuring the plurality of project silos, the operation optimization platform 102 may search a system maintained by an enterprise organization (e.g., a financial institution, and/or other institutions) for information to include in the project silo. Additionally or alternatively, in configuring the plurality of project silos, the operation optimization platform 102 may receive, from the system, an automatic notification indicating the information to include in the project silo.

The operation optimization platform 102 may configure the project silos over a period of time. For example, whenever a new project is created by a user (e.g., an employee of the enterprise organization, and/or other users of operation optimization platform 102) over a specific period of time (e.g., a year, a month, a day, and/or other periods of time) the operation optimization platform 102 may configure a project silo corresponding to the new project. In configuring the project silos, the operation optimization platform 102 may configure the project silos based on a project management ruleset (which may, e.g., be stored by operation optimization platform 102, e.g. at the operation optimization database 112b). For instance, in some examples, the project management rules may include instructions indicating that a new project for executing a particular operation (e.g., a SbD operation, a self-service operation, and/or other operations) be created every month. In these instances, based on the project management rules, a new project for the particular operation may be created every month (e.g., automatically created by a cybersecurity system and/or other systems, manually created by a user, such as an employee of the enterprise organization and/or other users, and/or created by other methods) and, accordingly, a new project silo corresponding to the new project may be configured by operation optimization platform 102 simultaneously.

In some examples, the project management ruleset may include one or more rules instructing a machine learning model (e.g., the operation optimization model described below at step 211, and/or other models) to configure the project silos. For instance, the project management ruleset may include a rule directing operation optimization platform 102 to execute the operation optimization model, which may, e.g., create one or more projects and configure a plurality of project silos corresponding to the one or more projects simultaneously.

In configuring the plurality of project silos, the operation optimization platform 102 may configure each project silo to include information related to the corresponding project. For example, a given project silo may include one or more of: a project name identifier, a project tag identifier, a list of permissions (which may, e.g., limit access to the project silo to users possessing particular authentication information, such as application-level authentication information and/or other information), a list of applications used within the project to perform the corresponding operation, a portion of the information used to execute the operation, and/or other information related to the project.

At step 202, the operation optimization platform 102 may generate a plurality of project tags based on the plurality of project silos. For example, the operation optimization platform 102 may generate a unique project tag for each different project silo. Each project tag may include multiple layers of information. For example, a given project tag may include operation-level information (e.g., an indication of the operation performed by the project, permissions and/or other requirements regulating access to information in subordinate layers of the project tag, and/or other operation-level information), project-level information (e.g., a stored correlation to the corresponding project silo, a project name, permissions and/or other requirements regulating access to information in subordinate layers of the project tag, and/or other project-level information), application-level information (e.g., a list of the applications used to execute the operation, permissions and/or other requirements regulating access to the results of executing one or more applications, and/or other application-level information), and/or other information. Each project tag may include additional layers of information that may, e.g., be determined by an enterprise user (e.g., an administrative employee of the enterprise organization, and/or other enterprise users).

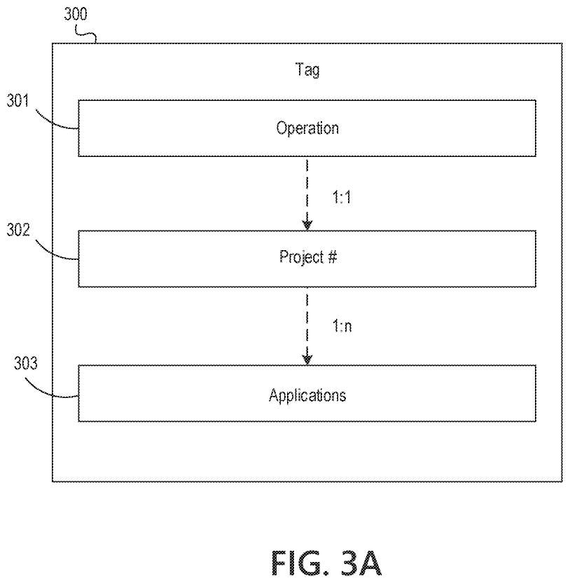

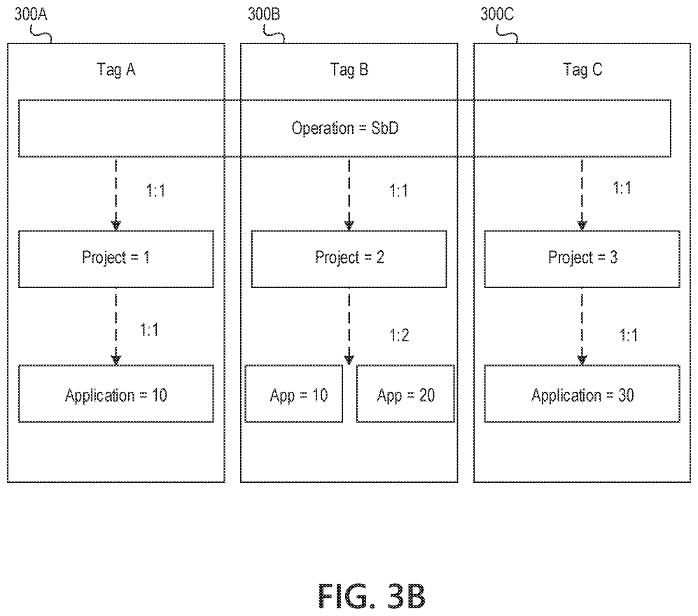

Each project tag may be generated such that the multiple layers of information are part of a hierarchy. For example, the application-level information may be subordinate to the project-level information, which may, e.g., be subordinate to the operation-level information. The hierarchy may be controlled, created, dictated, and/or otherwise established by a user of operation optimization platform 102 (e.g., an employee of the enterprise organization, and/or other users). For instance, the plurality of project tags may be generated with the multiple layers organized in a hierarchy as depicted by FIGS. 3A-3B.

Referring to FIG. 3A, an illustrative project tag used in a secure allocated resource tracking method for optimizing multiple operations in accordance with one or more example arrangements is shown. As described above with regard to step 202, the project tag 300 may include operation-level information 301 (e.g., an indication of the operation performed by the project, permissions and/or other requirements regulating access to information in subordinate layers of the project tag, and/or other operation-level information), project-level information 302 (e.g., a stored correlation to the corresponding project silo, a project name, permissions and/or other requirements regulating access to information in subordinate layers of the project tag, and/or other project-level information), application-level information 303 (e.g., a list of the applications used to execute the operation, permissions and/or other requirements regulating access to the results of executing one or more applications, and/or other application-level information). As shown in FIG. 3A, a given project tag, such as project tag 300, may have a 1:1 correspondence between operation-level information 301 and project-level information 302. For example, project tag 300 may include an indication of the operation performed by the project, and a project name. The 1:1 correspondence may indicate that project tag 300 includes information related to a single operation and to a single project. Project tag 300 may, in some instances, have a 1:n correspondence between project-level information 302 and application-level information 303, where n is a number of applications. For example, project tag 300 may include a project name and a list of three applications, where the three applications may all be used to execute the operation identified in operation-level information 301 by the project identified in project-level information 302.

Referring to FIG. 3B, an illustrative plurality of project tags corresponding to a same operation, used in a secure allocated resource tracking method for optimizing multiple operations in accordance with one or more example arrangements is shown. Each of the plurality of project tags 300A-C may be similar to the project tag 300 shown in FIG. 3A. Each of the plurality of project tags 300A-C may include operation-level information, project-level information, and application-level information. As shown in FIG. 3B, each of project tags 300A-C may include the same operation-level information because they each correspond to a project created to perform the same operation (e.g., operation SbD, and/or other operations). However, each project tag may correspond to a project that performs the operation using and/or on behalf of different applications. For example, project tag A 300A may include application-level information of a single application (e.g., application=10, which may, e.g., be and/or include and/or other applications). Project tag B 300B may include application-level information of multiple applications (e.g., application=10, application=20, and/or other applications). Project tag C 300C may include application-level information of a single application different from the application-level information in project tag A 300A (e.g., application=30, and/or other applications).

In some examples, the project tags (e.g., project tag 300, and/or other project tags) may exist as a set of information stored to a database (e.g., operation optimization database 112b, and/or other databases). In some instances, the project tags may additionally be configured to be displayed, via a graphical user interface, at the request of a user (e.g., a user of operation optimization platform 102, a user of first user device 104, and/or other users). For example, a graphical representation of project tag 300 and/or project tags 300A-C may be displayed via the graphical user interface.

Referring back to step 202 at FIG. 2A, in generating the plurality of project tags, the operation optimization platform 102 may parse, extract, and/or otherwise analyze the information included in each of the plurality of project silos to generate the corresponding project tags. The operation optimization platform 102 may store the plurality of project tags after they are generated, e.g., to internal memory of the operation optimization platform 102 (such as operation optimization database 112b, and/or other internal memory), and/or external memory.

At step 203, the operation optimization platform 102 may execute one or more computer operations (e.g., a SbD operation, a self-service operation, and/or other computer operations). For example, the operation optimization platform 102 may execute the operation corresponding to a plurality of project silos configured at step 201. In some instances, the operation optimization platform 102 may execute the same operation multiple times, once for each of the plurality of project silos. For example, the operation optimization platform 102 may be configured to execute the operation for a given silo of the plurality of project silos independent of the remaining project silos. In some examples, the operation optimization platform 102 may execute the one or more operations over a period of time (e.g., months, weeks, days, and/or other periods of time). For instance, an example operation may correspond to three different project silos (e.g., project silos generated at step 201), each generated at different times. The operation optimization platform 102 may execute the example operation on three different days, based on the time each project silo was generated.

In executing the one or more operations, the operation optimization platform 102 may further execute the applications identified by each project silo corresponding to an operation. The operation optimization platform 102 may execute the applications using a set of information corresponding to the operation being executed. For instance, each time the operation optimization platform 102 executes a particular operation, the operation optimization platform 102 may execute the operation using some or all of the same set of information used in a previous execution of the operation.

At step 204, based on executing the one or more operations, the operation optimization platform 102 may generate a record of the applications used to execute the one or more operations. In some instances, the operation optimization platform 102 may generate a separate record for each operation. For example, the operation optimization platform 102 may generate the record of applications by 1) parsing the application-level information of the project tag, of the plurality of project tags (e.g., the plurality of project tags generated at step 202), associated with each project silo (e.g., of the plurality of project silos configured at step 201) after the corresponding project performs execution of an operation, and 2) aggregating, based on parsing the application-level information, a record of the applications used to execute the operation across all projects corresponding to the plurality of project silos.

In some instances, the record of applications may be and/or include a list of the applications used to execute the operation, using a particular set of information corresponding to the operation. In these instances, the operation optimization platform 102 may store the list as a file in a database (e.g., operation optimization database 112b and/or other databases). Additionally or alternatively, in some examples, the operation optimization platform 102 may aggregate and store a set of identifiers, where each identifier in the set corresponds to a particular application used to execute the operation. In these examples, the operation optimization platform 102 may store the set of identifiers to internal memory of the operation optimization platform 102 (e.g., operation optimization database 112b, and/or other internal memory) and/or to external memory. In generating the record of applications, the operation optimization platform 102 may first generate a list and/or set of identifiers as described above and continually update the record of applications after additional instances of executing the operation. For example, after a first execution of the operation the operation optimization platform 102 may generate a record of applications that may be and/or include a list of all the applications included in the application-level information of a first project tag. The operation optimization platform 102 may then update the record of applications by adding additional entries to the list based on the application-level information of additional project tags (e.g., a second and third project tag, corresponding to a second and third execution of the operation, respectively).

Additionally, in some examples, the record of applications may additionally include the operation-level and project-level information associated with each application via the project tags. For example, the record of applications may be an aggregated file and/or set of information including all of the operation-level information and project-level information included in the plurality of project tags generated at step 202. Additionally or alternatively, the record of applications may be and/or include an aggregated list of identifiers corresponding to each project tag that may, e.g., be used to access the information included in each project tag (e.g., based on a request from a user). In some instances, the record of applications may additionally or alternatively include a list of permissions for granting access to some or all of the record of applications (which may, e.g., be included in the operation-level information, the project-level information, application-level information, and/or other information in the plurality of project tags). While generating the record of applications is described as being performed after executing the one or more operations, the record of applications may be generated during the executing the one or more operations (e.g., the record may be generated and/or updated after each instance of executing an operations) without departing from the scope of this disclosure.

Referring to FIG. 2B, at step 205, the operation optimization platform 102 may establish a connection with first user device 104. For example, operation optimization platform 102 may establish a first wireless data connection with the first user device 104 via the communication interface 113 to link the first user device 104 with the operation optimization platform 102 (e.g., in preparation for receiving requests to access the record of applications, sending application information, and/or other functions). In some instances, the operation optimization platform 102 may identify whether or not a connection is already established with the first user device 104. If a connection is already established with the first user device 104, the operation optimization platform 102 might not re-establish the connection. If a connection is not yet established with the first user device 104, the operation optimization platform 102 may establish the first wireless data connection as described above.

Additionally or alternatively, at step 205, the operation optimization platform 102 may establish a connection with second user device 106. For example, operation optimization platform 102 may establish a second wireless data connection with the second user device 106 via the communication interface 113 to link the second user device 106 with the operation optimization platform 102 (e.g., in preparation for receiving requests to access the record of applications, sending operation information, and/or other functions). In some instances, the operation optimization platform 102 may identify whether or not a connection is already established with the second user device 106. If a connection is already established with the second user device 106, the operation optimization platform 102 might not re-establish the connection. If a connection is not yet established with the second user device 106, the operation optimization platform 102 may establish the second wireless data connection as described above.

At step 206, the first user device 104 may send a request to access a portion of the record of applications to the operation optimization platform 102. For example, the first user device 104 may send a request to access application-level information corresponding to one or more applications. Based on first user device 104 sending the request, the operation optimization platform 102 may receive the request to access the portion of the record of applications from the first user device 104. The first user device 104 may have sent the request via the communication interface 113 and while the first wireless data connection is established. In these instances, the operation optimization platform 102 may receive the request via the communication interface 113 and while the first wireless data connection is established. The request may be sent by the first user device 104 and received by the operation optimization platform 102 based on user input. For example, the user (e.g., an employee of the enterprise organization, such as an administrative employee, a developer employee, and/or other employees) may provide user input to the first user device 104 directing the first user device 104 to send the request to the operation optimization platform 102.

The request to access the record of applications may indicate information necessary for the operation optimization platform 102 to determine what information from the record of applications is being requested. For example, in some instances, the request to access the record may include a request tag. A request tag may include one or more identifiers that indicate one or more of: a requested selection of the operation-level information included in the record of applications, a requested selection of the project-level information included in the record of the applications, a requested selection of the application-level information included in the record of applications, and/or other information. The request tag may be and/or include a demarcated list of the requested information from the record of applications, such as: <operation, project, application>. For instance, with reference to FIG. 3B, the request tag <operation: SbD, project 1, application 10> may request the operation-level information, project-level information, and application-level information corresponding to tag A 300A. In another example, the request tag <operation: SbD, project 2, application 10> may request the operation-level and project-level information from project tag B 300B, but only the application-level information corresponding to the application associated with application 10 and corresponding to project tag B 300B.

In some examples, the request to access the record of applications may additionally include authentication information corresponding to the user and/or to the first user device 104. The authentication information may include one or more of: authorization codes, passwords, encryption keys, IP (internet protocol) addresses, and/or other authentication information. For example, the authentication information may indicate that the user and/or the first user device 104 is only authorized to access information related to specific applications. For instance, the authentication information may include one or more application access keys (and/or other access information) indicating that the user is only authorized to access information from the record of applications related to application 10.

In some instances, the operation optimization platform 102 may receive a plurality of requests over a given period of time. For example, the operation optimization platform 102 may receive a first request from a first user device corresponding to a first user (e.g., first user device 104), and a second request from a second user device (e.g., second user device 106) corresponding to a second user (e.g., as described below at steps 209-211). Additionally or alternatively, the operation optimization platform 102 may receive multiple requests from a single device (e.g., first user device 104, second user device 106, and/or other user devices). Each distinct request may cause the operation optimization platform 102 to perform some or all of steps 207-212, as described below.

Referring back to FIG. 2B, at step 207, the operation optimization platform 102 may determine whether or not to grant access to the record of applications based on the request received from the first user device 104. In determining whether or not to grant access, the operation optimization platform 102 may compare authentication information which may be included in the request to access the record of applications (e.g., as described above at step 206) with a list of permissions (which may, e.g., be included in the record of applications). For example, as described above with regard to step 206, the request may be and/or include request tag <operation: SbD, project 1, application 10> and may be received by operation optimization platform 102 from the first user device 104. The list of permissions in the record of applications may indicate, for example, that access to the application-level information corresponding to application 10 requires authentication information similarly corresponding to application 10. In some instances, the request may include authentication information indicating that the user is authorized to access the results of performing the operation using the application corresponding to application 10. Accordingly, based on comparing the list of permissions and the authentication information, the operation optimization platform 102 may determine that the user and/or first user device 104 should be granted access to the requested portion of the record of applications. In another example, the request may include authentication information indicating that the user is authorized to access the results of performing the operation using the application corresponding to application 20. In contrast to the example described above, based on comparing the list of permissions and the authentication information, the operation optimization platform 102 may determine that the user and/or first user device 104 should not be granted access to the requested portion of the record of applications.

Additionally or alternatively, in some instances, based on comparing the list of permissions with the authentication information, the operation optimization platform 102 may determine that the first user device 104 should be granted access to a portion, but not all, of the requested information from the record of applications. For example, the request tag <operation: SbD, project 1.*> may request all of the information for each application used in project 1. The request may include authentication information only corresponding to a single application (e.g., application 10). Accordingly, based on comparing the list of permissions with the authentication information, the operation optimization platform 102 may determine that the first user device 104 should be granted access to the portion of the record of applications corresponding to the single application (e.g., application 10), but not to any other requested portions of the record of applications.

In some instances, the request may be and/or include a request tag (e.g., <operation X, project X, application X>, and/or other request tags) which requests only application-level information for a single application (e.g., application X, and/or other applications) and may include authentication information corresponding to the requested application-level information. In these examples, the operation optimization platform 102 may determine that the first user device 104 should be granted access to the requested portion of the record of applications and accordingly may send the requested portion of the record of applications to the first user device 104. In these instances, the operation optimization platform 102 may proceed to step 208, as described below.

Additionally or alternatively, in some examples, the request may be and/or include a request tag (e.g., <operation X, project X, application X>, and/or other request tags) which requests only application-level information for a single application (e.g., application X, and/or other applications) and may include authentication information corresponding to a different application (e.g., application Y, and/or other applications). In these examples, the operation optimization platform 102 may determine that the first user device 104 should not be granted access to the requested portion of the record of applications and may, instead, send a notification to the first user device 104 indicated access was denied. In these examples, the operation optimization platform 102 may proceed to step 212, as described below, and may not perform steps 208-211.

In some examples, the operation optimization platform 102 may have received multiple requests over a period of time (e.g., as described above at step 206). In these instances, the operation optimization platform 102 may determine whether or not to grant access based on each request individually, and proceed to one of step 208 or 212 accordingly, as described above.

At step 208, based on 1) receiving a request from first user device 104 including a request tag corresponding only to application-level information in the record of applications, and 2) determining, based on comparing a list of user permissions with authentication information corresponding to the request, that the first user device 104 should be granted access to the requested application-level information, the operation optimization platform 102 may send the portion of the record of applications corresponding to the requested application-level information to the first user device 104. For example, the operation optimization platform 102 may send the portion of the record of applications via the communication interface 113 and while the first wireless data connection is established. Based on operation optimization platform 102 sending of the portion of the record of applications, the first user device 104 may receive the portion of the record of applications.

In some examples, in sending the portion of the record of applications to the first user device 104, the operation optimization platform 102 may additionally send one or more display commands directing the first user device 104 to display a user interface. For example, the operation optimization platform 102 may send the one or more display commands via the communication interface 113 and while the first wireless data connection is established. Based on or in response to the one or more commands to display the user interface, the first user device 104 may display the user interface. For example, the first user device 104 may display an application-level information interface.

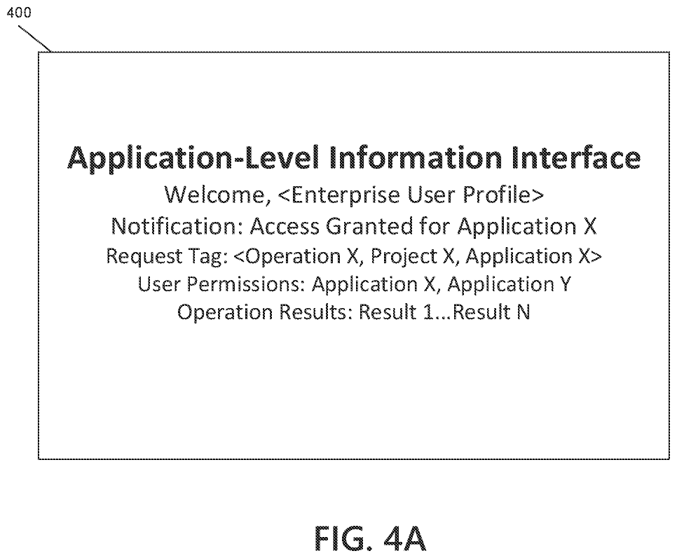

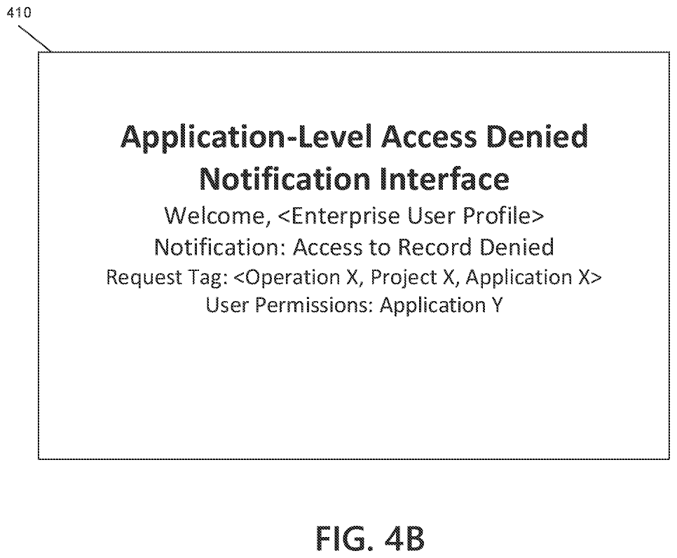

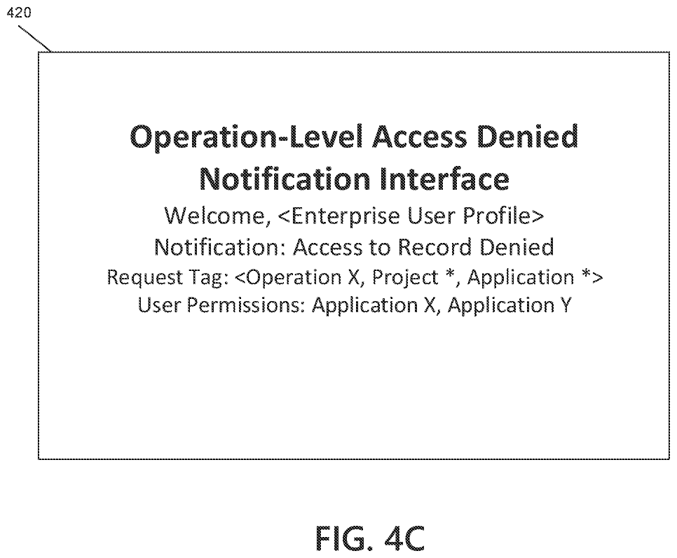

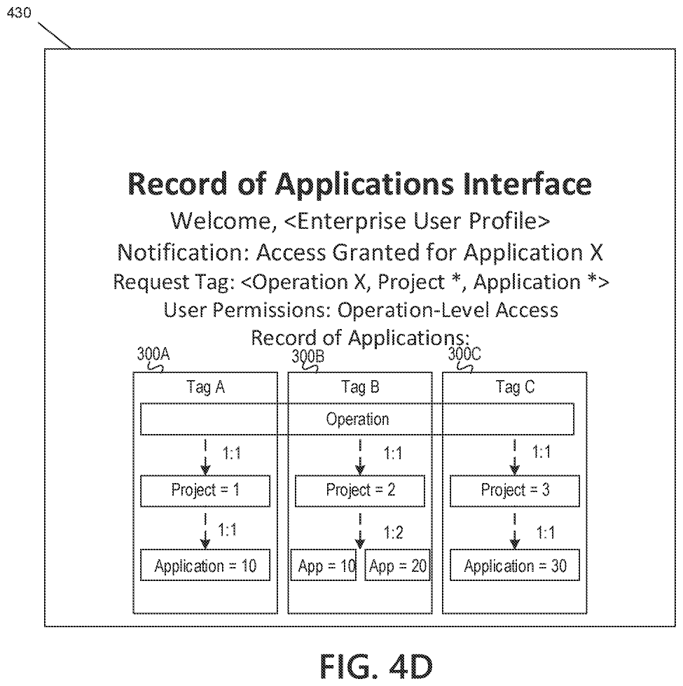

For example, in displaying an application-level information interface, first user device 104 may display a graphical user interface similar to application-level information interface 400, which is illustrated in FIG. 4A. Referring to FIG. 4A, in some instances, the application-level information interface 400 may include information corresponding to the request sent by first user device 104 (e.g., as described at step 206 above). For example, the application-level information interface 400 may include information such as a notification that access to the requested portion of the record of applications has been granted, the request tag, a representation of user permissions corresponding to the authentication information included in the request, the requested application-level information from the record of applications (e.g., the results of executing the operation indicated by the request tag using the applications indicated by the request tag, and/or other application-level information) and/or other information.

Referring back to FIG. 2B at step 208, in some instances, the operation optimization platform 102 may, based on sending the portion of the record of applications, proceed to step 213. In these instances, the operation optimization platform 102 may not perform the actions described at steps 209-212 below.

Referring to FIG. 2C, at step 209, the second user device 106 may send a request to access a portion of the record of applications to the operation optimization platform 102. For example, the second user device 106 may send a request to access operation-level information corresponding to one or more applications. Based on second user device 106 sending the request, the operation optimization platform 102 may receive the request to access the portion of the record of applications from the second user device 106. The second user device 106 may have sent the request via the communication interface 113 and while the second wireless data connection is established. In these instances, the operation optimization platform 102 may receive the request via the communication interface 113 and while the second wireless data connection is established. The request may be sent by the second user device 106 and received by the operation optimization platform 102 based on user input. For example, the user (e.g., an employee of the enterprise organization, such as an administrative employee, a developer employee, and/or other employees) may provide user input to the second user device 106 directing the second user device 106 to send the request to the operation optimization platform 102.

The request to access the record of applications may indicate information necessary for the operation optimization platform 102 to determine what information from the record of applications is being requested. For example, similar to the request for application-level information described above at step 206, in some instances, the request to access the record may include a request tag. The request tag may include one or more identifiers that indicate one or more of: a requested selection of the operation-level information included in the record of applications, a requested selection of the project-level information included in the record of the applications, a requested selection of the application-level information included in the record of applications, and/or other information. The request tag may be and/or include a demarcated list of the requested information from the record of applications, such as: <operation, project, application>.

Additionally or alternatively, in some instances, a request tag may include an indicator (e.g., a character, wildcard operator, command, and/or other indicator) requesting all of the information, included in the record of applications, and corresponding to a specific layer of one or more multi-layered project tags. For example, with further reference to FIG. 3B, the request tag <operation: SbD, project 2, *> may request all of the application-level information corresponding to tag B 300B, regardless of which applications were used by project 2 to execute the operation: SbD. As another example, the request tag <operation: SbD. *, *> may request all of the application-level and project-level information corresponding to operation SbD that is included in the record of applications (i.e., all of the information corresponding to tags 300A-C).

In some examples, the request to access the record of applications may additionally include authentication information corresponding to the user and/or to the second user device 106. The authentication information may include one or more of: authorization codes, passwords, encryption keys, IP (internet protocol) addresses, and/or other authentication information. In some instances, the authentication information may indicate that the user and/or the second user device 106 is authorized to access operation-level information and all subordinate information in the multi-layer hierarchy.

Referring back to FIG. 2C, at step 210, the operation optimization platform 102 may determine whether or not to grant access to the record of applications based on the request received from the second user device 106. In determining whether or not to grant access, the operation optimization platform 102 may compare authentication information which may be included in the request to access the record of applications with a list of permissions (which may, e.g., be included in the record of applications). For example, the operation optimization platform 102 may determine whether or not to grant access based on the request tags included in the request from second user device 106, using the methods described above at step 207. For example, based on comparing a list of permissions and the authentication information, the operation optimization platform 102 may determine that the user and/or second user device 106 should be granted access to the requested portion of the record of applications.

Additionally or alternatively, in some examples, the request may be and/or include a request tag (e.g., <operation X, Project *, application *>, and/or other request tags) which requests operation-level information corresponding to a specific operation (e.g., operation X, and/or other operations) and the request may include authentication information indicating the user and/or second user device 106 should be granted access to all portions of the record of applications corresponding to the specific operation. In these examples, the operation optimization platform 102 may determine that the second user device 106 should be granted access to the requested portion of the record of applications and may send the requested portion to the second user device 106. In these instances, the operation optimization platform 102 may proceed to step 211, as described below, and may not perform step 212.

In another example, the request may be and/or include a request tag (e.g., <operation X, project *, application *>, and/or other request tags) requesting operation-level information and all subordinate information corresponding to a specific operation (e.g., operation X, and/or other operations) yet may only include authentication information corresponding to one or more applications (e.g., application X, application Y, and/or other applications). In these examples, the operation optimization platform 102 may determine that the second user device 106 should not be granted access to the requested portion of the record of applications and may, instead, send a notification to the second user device 106 indicated access was denied. In these examples, the operation optimization platform 102 may proceed to step 212, as described below, and may not perform step 211.

At step 211, based on 1) receiving a request from second user device 106 including a request tag corresponding to operation-level information and all subordinate information for a particular operation and 2) determining, based on comparing a list of user permissions with authentication information corresponding to the request, that the second user device 106 should be granted access to the requested information, the operation optimization platform 102 may send the portion of the record of applications corresponding to the requested information to the second user device 106. For example, the operation optimization platform 102 may send the portion of the record of applications via the communication interface 113 and while the second wireless data connection is established. Based on operation optimization platform 102 sending of the portion of the record of applications, the second user device 106 may receive the portion of the record of applications.

In some examples, in sending the portion of the record of applications to the second user device 106, the operation optimization platform 102 may additionally send one or more display commands directing the second user device 106 to display a user interface. For example, the operation optimization platform 102 may send the one or more display commands via the communication interface 113 and while the second wireless data connection is established. Based on or in response to the one or more commands to display the user interface, the second user device 106 may display the user interface. For example, the second user device 106 may display a record of applications interface.

For example, in displaying record of applications interface, second user device 106 may display a graphical user interface similar to record of applications interface 430, which is illustrated in FIG. 4D. Referring to FIG. 4D, in some instances, the record of applications interface 430 may include information corresponding to the request sent by second user device 106 (e.g., as described at step 206 above). For example, the record of applications interface 430 may include information such as a notification that access to the requested portion of the record of applications has been granted, the request tag, a representation of user permissions corresponding to the authentication information included in the request, and/or other information. Additionally or alternatively, the record of applications interface 430 may include some or all of the record of applications, based on the request tag. For example, as illustrated in FIG. 4D, the record of applications interface 430 may include representations of a plurality of project tags (e.g., project tags 300A-C, as described above with respect to FIG. 3B), wherein the plurality of project tags includes a listing of all of applications used by each project to perform a particular operation.

Referring back to FIG. 2C at step 211, in some instances the operation optimization platform 102 may, based on sending the portion of the record of applications, proceed to step 213. In these instances, the operation optimization platform 102 may not perform the actions described at step 212.

At step 212, based on 1) receiving a request from first user device 104 and/or second user device 106 including a request tag and 2) determining, based on comparing a list of user permissions with authentication information corresponding to the request, that the first user device 104 and/or second user device 106 should be not granted access to the information corresponding to the request tag, the operation optimization platform 102 may cause display of a notification at the first user device 104 and/or second user device 106. For example, in causing display of the notification, the operation optimization platform 102 may send a notification to first user device 104 via the communication interface 113 and while the first wireless data connection is established. In some examples, in causing display of the notification, the operation optimization platform 102 may further send one or more display commands directing the first user device 104 to display a user interface. For example, the operation optimization platform 102 may send the one or more display commands via the communication interface 113 and while the first wireless data connection is established. Based on or in response to the one or more commands to display the user interface, the first user device 104 may display the user interface. For example, the first user device 104 may display an access denied notification interface.

For example, based on a request for application-level information and based on a determination that the first user device 104 should be denied access, in displaying an access denied notification interface, first user device 104 may display a graphical user interface similar to application-level access denied notification interface 410, which is illustrated in FIG. 4B. Referring to FIG. 4B, in some instances, the application-level access denied notification interface 410 may include information corresponding to the request sent by first user device 104 (e.g., as described at step 206 above). For example, the application-level access denied notification interface 410 may include information such as a notification that access to the requested portion of the record of applications has been denied, the request tag, a representation of user permissions corresponding to the authentication information included in the request, and/or other information.

Additionally or alternatively, in causing display of the notification, the operation optimization platform 102 may send a notification to second user device 106 via the communication interface 113 and while the second wireless data connection is established. In some examples, in causing display of the notification, the operation optimization platform 102 may further send one or more display commands directing the second user device 106 to display a user interface. For example, the operation optimization platform 102 may send the one or more display commands via the communication interface 113 and while the second wireless data connection is established. Based on or in response to the one or more commands to display the user interface, the second user device 106 may display the user interface. For example, the second user device 106 may display an access denied notification interface

For example, based on a request for operation-level information and all subordinate information corresponding to a particular operation and based on a determination that the second user device 106 should be denied access, in displaying an access denied notification interface, second user device 106 may display a graphical user interface similar to operation-level access denied notification interface 420, which is illustrated in FIG. 4C. Referring to FIG. 4C, in some instances, the operation-level access denied notification interface 420 may include information corresponding to the request sent by second user device 106 (e.g., as described at step 206 above). For example, the operation-level access denied notification interface 420 may include information such as a notification that access to the requested portion of the record of applications has been denied, the request tag, a representation of user permissions corresponding to the authentication information included in the request, and/or other information.

Referring to FIG. 2D, at step 213, the operation optimization platform 102 may train an operation optimization model to output one or more project management rules (e.g., for use in a project management ruleset governing creation of projects and/or configuration of project silos). In some instances, the operation optimization platform 102 may configure and/or otherwise train the operation optimization model based on one or more preexisting project management rulesets and based on one or more preexisting records of applications. For example, the operation optimization platform 102 may configure and/or otherwise train the operation optimization model based on the project management ruleset described above at step 201 and/or additional project management rulesets created by the enterprise organization corresponding to operation optimization platform 102. In some instances, to configure and/or otherwise train the operation optimization model, the operation optimization platform 102 may process the preexisting project management rulesets and the preexisting records of applications by applying natural language processing, natural language understanding, supervised machine learning techniques (e.g., regression, classification, neural networks, support vector machines, random forest models, naïve Bayesian models, and/or other supervised techniques), unsupervised machine learning techniques (e.g., principal component analysis, hierarchical clustering, K-means clustering, and/or other unsupervised techniques), and/or other techniques. In doing so, the operation optimization platform 102 may train the operation optimization model to output project management rules based on input of records of applications.

For example, in configuring and/or otherwise training the operation optimization model, the operation optimization platform 102 may input a matched pairing of a given project management ruleset (i.e., a preexisting project management ruleset) and a preexisting record of applications. The preexisting record of applications may have been used (e.g., by an employee of the enterprise organization, and/or by other individuals or groups of individuals) to generate the preexisting project management ruleset. For instance, in one or more examples, a user of operation optimization platform 102 (e.g., an employee of the enterprise organization, and/or other users) may have manually analyzed the preexisting project management ruleset to determine one or more rules to include as part of the preexisting project management ruleset. Based on inputting the preexisting project management ruleset and the preexisting record of applications to the operation optimization model, the operation optimization platform 102 may identify, using the operation optimization model, information of one or more rules of the preexisting project management ruleset (e.g., a rule for merging project silos, a rule for creating project silos, a rule for removing project silos, and/or other rules) corresponding to information of the preexisting record of applications (e.g., two or more project silos sharing the same application, two or more project silos sharing multiple applications, two or more project silos, each using different applications, and/or other information). The operation optimization platform 102 may store a correlation between the identified information of the preexisting project management ruleset and the information of the preexisting record of applications (e.g., to internal memory of the operation optimization platform 102, such as machine learning engine 112c, and/or external memory). The operation optimization platform 102 (e.g., machine learning engine 112c) may train the operation optimization model, based on the stored correlations, to generate similar rules for future project management rulesets when the operation optimization model identifies similar information in future records of applications.

For example, based on inputting a preexisting record of applications and a matched preexisting project management ruleset, the operation optimization platform 102 may identify that the preexisting project management ruleset includes a rule to merge project silos sharing a particular application (e.g., application 10, and/or other applications) into a single project silo. The operation optimization platform 102 may further identify that the rule to merge project silos was generated (e.g., by a user, and/or by other methods) based on information in the preexisting record of applications indicating that two project silos shared the same particular application. Accordingly, the operation optimization platform 102 may train the operation optimization model to generate a rule to merge project silos sharing additional applications based on input of a record of applications indicating two or more project silos share at least one additional application. Additionally or alternatively, in another example, the operation optimization platform 102 may train the operation optimization model to generate a rule for removing (e.g., deleting, terminating, and/or otherwise removing) a project silo entirely. For example, the operation optimization platform 102 may mine the preexisting project management ruleset and the preexisting record of applications to identify that when a record of applications indicates two or more project silos share the exact same application-level information, a rule may be included in a project management ruleset directing all but one of the project silos sharing the same application-level information to be removed. The operation optimization platform 102 may then train the operation optimization model to generate similar rules based on receiving input of a record of applications indicating two or more project silos share a different set of application-level information.

At step 214, the operation optimization platform 102 may input the record of applications (e.g., the record of applications generated at step 204, as described above) into the operation optimization model. Based on inputting the record of applications into the operation optimization model the operation optimization platform 102 may generate, as output of the operation optimization model, one or more project management rules. In outputting the one or more project management rules, the operation optimization model may use the methods the operation optimization platform 102 trained the operation optimization model to use when generating project management rules (e.g., as described above at step 211). For example, the operation optimization model may analyze the information of the record of applications to generate one or more project management rules based on similarities between project silos indicated by the record of applications. In some examples, based on input of a record of applications indicating at least two project silos share a same portion of application-level information, the operation optimization model may output a rule for merging project silos. For instance, based on a record of applications indicating two project silos share a single application (e.g., application 10, and/or other applications) the operation optimization model may output a rule directing operation optimization platform 102 to merge all project silos that share the single application (i.e., deduplication). Additionally or alternatively, in some examples, based on input of a record of applications indicating at least two project silos share a same portion of application-level information, the operation optimization model may output a rule for creating project silos. For instance, based on a record of applications indicating two project silos share a single application (e.g., application 20, and/or other applications) the operation optimization model may output a rule directing operation optimization platform 102 to create and/or configure a project silo including the single application at a particular interval of time (e.g., a rule directing the project silo to be created and/or configured weekly, monthly, annually, and/or at other intervals of time). In these instances, the operation optimization model may additionally or alternatively output a rule directing that no further project silos including the single application will be created and/or configured by operation optimization platform 102.

Additionally or alternatively, in some examples, based on input of a record of applications indicating at least two project silos do not share any application-level information, the operation optimization model may output a rule for creating project silos. For instance, based on input of a record of applications indicating a first project silo includes only application-level information corresponding to a particular application (e.g., application 10, and/or other applications) and a second project silo includes only application-level information corresponding to a different application (e.g., application 20, and/or other applications) the operation optimization model may output a rule directing a project silo including application-level information corresponding to both applications (e.g., application 10 and application 20) to be created and/or configured by operation optimization platform 102. Additionally or alternatively, in some examples, based on input of a record of applications indicating at least two project silos share a same portion of application-level information, the operation optimization model may output a rule for removing project silos. For instance, based on a record of applications indicating two project silos share a single application (e.g., application 30, and/or other applications) the operation optimization model may output a rule directing operation optimization platform 102 to delete, terminate, and/or otherwise remove one of the two project silos from the record of applications and/or from memory of operation optimization platform 102.

The operation optimization model may output some or all of the exemplary rules described above as the one or more rules. Additionally or alternatively, the operation optimization model may output additional and/or different rules to those described above, based on the training operation optimization platform 102 provided the operation optimization model and based on the record of applications input to the operation optimization model, without departing from the scope of this disclosure.

At step 215, the operation optimization platform 102 may modify a project management ruleset (e.g., the project management rules used to configure the project silos at step 201, and/or other project management rulesets) based on the one or more rules output by the operation optimization model. For example, the operation optimization platform 102 may add one or more rules (e.g., rules described above at step 212, and/or other rules) to the project management ruleset, including one or more of: rules for creating project silos, rules for merging project silos, rules for removing project silos, and/or other rules. Additionally or alternatively, in some instances, in modifying the project management ruleset, the operation optimization platform 102 may merge one or more rules output by the operation optimization model with an existing rule of the project management ruleset. For example, the operation optimization model may output a first rule directing a project silo including a particular application (e.g., application 10, and/or other applications) to be created monthly, while an existing rule may direct a project silo including a different application (e.g., application 20, and/or other applications) to be created monthly. Accordingly, the operation optimization platform 102 may merge the first rule with the existing rule, resulting in a single rule directing a project silo including both applications (e.g., application 10 and application 20) to be created monthly.

Additionally or alternatively, in some examples, in modifying the project management ruleset the operation optimization platform 102 may modify access permissions for one or more project silos based on the one or more rules output by the operation optimization model. For example, based on a rule directing operation optimization platform 102 to merge two or more project silos, the operation optimization platform 102 may modify the access permissions for the merged project silo such that any user with authentication information granting access to one of the two or more project silos may be granted access to the merged project silo. Modifying the project management ruleset may optimize an operation by creating a more efficient ruleset for configuring and/or creating project silos for future instances of executing the operation. In modifying the project management ruleset as described above, the operation optimization platform 102 may generate a modified project management ruleset.

In some instances, based on generating the modified project management ruleset, the operation optimization platform 102 may cause a project management update. For example, the operation optimization platform 102 may use the modified project management ruleset as an updated ruleset for generating new project silos. Additionally or alternatively, the operation optimization platform 102 may cause the project management update by sending the modified project management ruleset to a user device (e.g., first user device 104, second user device 106, and/or other user devices) to provide instructions to the user of the user device for generating new project silos.

At step 216, based on the modified project management ruleset, the operation optimization platform 102 may refine, validate, and/or otherwise update the operation optimization model. In some instances, updating the operation optimization model may include inputting the modified project management ruleset into the operation optimization model. By inputting the modified project management ruleset into the operation optimization model, the operation optimization platform 102 may create an iterative feedback loop that may continuously and dynamically refine the operation optimization model to improve its accuracy. For example, the operation optimization platform 102 may identify that the modified project ruleset includes a rule for merging project silos based on input of a record of applications indicating at least two project silos include a same portion of application level information. In these examples, the operation optimization platform 102 may update the operation optimization model to automatically cause a rule for merging project silos to be output based on input of a record of applications indicating at least two project silos include the same portion of application-level information in future iterations of the feedback loop. Additionally or alternatively, in some instances, the operation optimization platform 102 may identify that the modified project ruleset includes a rule for creating project silos based on input of a record of applications indicating at least two project silos include a same portion of application level information. In these examples, the operation optimization platform 102 may update the operation optimization model to automatically cause a rule for creating project silos to be output based on input of a record of applications indicating at least two project silos include the same portion of application-level information in future iterations of the feedback loop. Additionally or alternatively, in some instances, the operation optimization platform 102 may identify that the modified project ruleset includes a rule for creating project silos based on input of a record of applications indicating no two project silos include a same portion of application level information. In these examples, the operation optimization platform 102 may update the operation optimization model to automatically cause a rule for creating project silos to be output based on input of a record of applications indicating no two project silos include the same portion of application-level information in future iterations of the feedback loop. Additionally or alternatively, in some instances, the operation optimization platform 102 may identify that the modified project ruleset includes a rule for removing project silos based on input of a record of applications indicating at least two project silos include a same portion of application level information. In these examples, the operation optimization platform 102 may update the operation optimization model to automatically cause a rule for removing project silos to be output based on input of a record of applications indicating at least two project silos include the same portion of application-level information in future iterations of the feedback loop. In updating the operation optimization model, the operation optimization platform 102 may improve the accuracy and effectiveness of the rule generation process by the operation optimization model, which may, e.g., result in more efficient training of models by the operation optimization platform 102 (and may, in some instances, conserve computing and/or processing power/resources in doing so). For example, the operation optimization platform 102 may reduce the number of duplicate rules and/or unused rules output by the operation optimization model in future iterations of the feedback loop, reducing the computing and/or processing power/resources required to execute the operation optimization model.

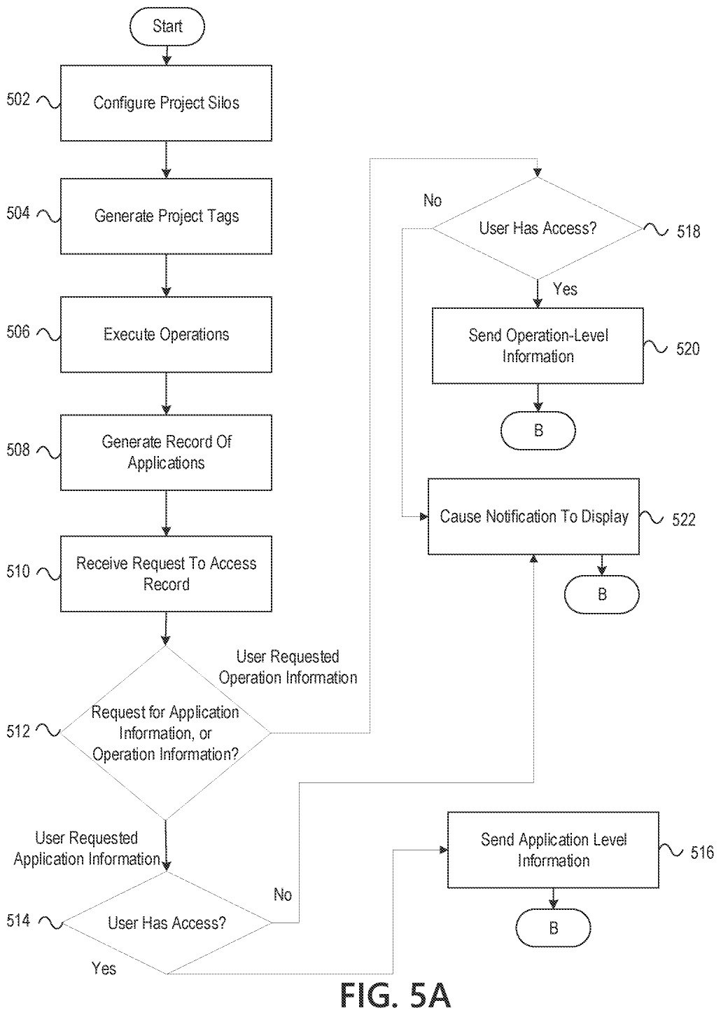

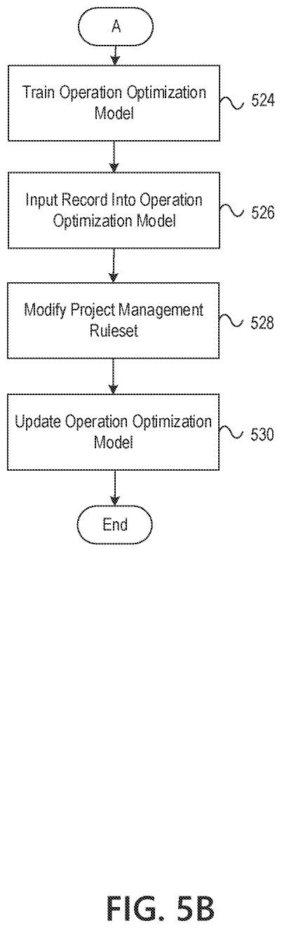

FIGS. 5A-5B depict an illustrative method for a secure allocated resource tracking method for optimizing multiple operations in accordance with one or more example arrangements. Referring to FIG. 5, at step 502, a computing platform having at least one processor, a communication interface, and memory may configure a plurality of project silos. At step 504, the computing platform may generate a plurality of project tags. At step 506, the computing platform may execute one or more operations. At step 508, the computing platform may generate a record of applications used to execute the one or more operations. At step 510, the computing platform may receive a request to access the record of applications. At step 512, based on the request, the computing platform may determine whether a user has requested application-level information or operation-level information. Based on a determination that the user requested application-level information, the computing platform may proceed to step 514. Based on a determination that the user has requested operation-level information, the computing platform may proceed to step 518. At step 514, the computing platform may determine whether or not the user has access to the requested information. Based on a determination that the user does have access to the requested information, the computing platform may proceed to step 516. Based on a determination that the user does not have access to the requested information, the computing platform may proceed to step 522. At step 516, the computing platform may send the application-level information. Based on sending the application-level information, the computing platform may proceed to step 524 at FIG. 5B

At step 518, the computing platform may determine whether or not the user has access to the requested operation-level information. Based on a determination that the user does have access to the requested operation-level information, the computing platform may proceed to step 520. Based on a determination that the user does not have access to the requested operation-level information, the computing platform may proceed to step 522. At step 520, the computing platform may send the operation-level information. Based on sending the operation-level information, the computing platform may proceed to step 524 at FIG. 5B. At step 522, the computing platform may cause a notification to display. Based on causing the notification to display, the computing platform may proceed to step 524 at FIG. 5B.

Referring to FIG. 5B, at step 524, the computing platform may train an operation optimization model. At step 526, the computing platform may input the record of applications into the operation optimization model. Based on inputting the record of applications, the operation optimization model may output one or more rules. At step 528, based on the one or more rules, the computing platform may modify a project management ruleset. At step 530, based on the modified project management ruleset, the computing platform may update the operation optimization model.

One or more aspects of the disclosure may be embodied in computer-usable data or computer-executable instructions, such as in one or more program modules, executed by one or more computers or other devices to execute the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
configure, based on a project management ruleset, a plurality of project silos corresponding to a first operation performed using a first set of information;
generate, based on the plurality of project silos, a plurality of project tags, wherein each project tag corresponds to a different project silo, of the plurality of project silos, wherein a given project tag comprises:
operation-level information corresponding to the first operation;
project-level information of the corresponding project silo; and
application-level information corresponding to at least one application included in the project silo;
execute at least one performance of the first operation using the first set of information;
generate, based on the application-level information of each project tag, a record of applications performing the first operation and using the first set of information;
receive, from a first user device corresponding to a first user, a first request to access the record of applications, wherein the first request comprises:
authentication information corresponding to the first user; and
a first request tag, wherein the first request tag comprises at least one of:
a selection of requested operation-level information,
a selection of requested project-level information, and
a selection of requested application-level information;
determine, based on comparing the authentication information to a list of permissions associated with the record of applications, whether or not to grant the first user device access to the record of applications;
send, based on determining to grant the first user device access to the record of applications, a first portion of the record of applications to the first user device, wherein the first portion of the record of applications corresponds to the first request tag;
input the record of applications into an operation optimization model, wherein inputting the record of applications into the operation optimization model causes the operation optimization model to output one or more project management rules; and
modify, based on the one or more project management rules, the project management ruleset, wherein the modifying produces a modified project management ruleset.

2. The computing platform of claim 1, wherein the memory stores additional computer-readable instructions that, when executed by the at least one processor, cause the computing platform to:
receive, from a second user device corresponding to a second user, a second request to access the record of applications, wherein the second request comprises:
application-level authentication information; and
a second request tag, wherein the second request tag comprises at least one of:
a selection of requested operation-level information,
a selection of requested project-level information, and
a selection of requested application-level information;
determine, based on comparing the application-level authentication information to a list of permissions associated with the record of applications, whether or not to grant the second user device access to the record of applications; and
send, based on determining to grant the second user device access to the record of applications, a second portion of the record of applications to the second user device, wherein the second portion of the record of applications corresponds to the second request tag.

3. The computing platform of claim 1, wherein the memory stores additional computer-readable instructions that, when executed by the at least one processor, cause the computing platform to:
train, prior to inputting the record of applications and based on the project management ruleset, the operation optimization model to output the one or more project management rules based on input of a given record of applications; and
update, based on the modified project management ruleset, the operation optimization model, wherein the updating causes the operation optimization model to perform one or more of:
output, based on input of a record of applications indicating at least two project silos include a same portion of application-level information, a rule for merging project silos,
output, based on input of a record of applications indicating at least two project silos include a same portion of application-level information, a rule for creating project silos, or
output, based on input of a record of applications indicating at least two project silos include a same portion of application-level information, a rule for removing project silos.

4. The computing platform of claim 1, wherein a given project silo, of the plurality of project silos, comprises:
a project name identifier;
a project tag identifier;
a list of permissions, wherein the list of permissions limits access to the project silo;
a list of applications used to perform the first operation; and
at least a portion of the first set of information.

5. The computing platform of claim 1, wherein the configuring the plurality of project silos corresponding to the first operation is performed by the operation optimization model.

6. The computing platform of claim 1, wherein the configuring the plurality of project silos corresponding to the first operations is performed based on user input.

7. The computing platform of claim 1, wherein the modifying the project management ruleset comprises at least one of:
adding a rule, of the one or more project management rules, for creating project silos;
adding a rule, of the one or more project management rules, for merging project silos;
adding a rule, of the one or more project management rules, for removing project silos;
merging a rule, of the one or more project management rules, with an existing rule; or
modifying, based on the one or more project management rules, access permissions for one or more project silos.

8. The computing platform of claim 1, wherein the memory stores additional computer-readable instructions that, when executed by the at least one processor, cause the computing platform to:
cause, based on determining not to grant the first user device access to the record of applications, the first user device to display a notification interface, wherein the notification interface indicates the first user is not authorized to access the record of applications; and
send, based on the modifying, a project management update to the first user device, wherein the project management update comprises the modified project management ruleset.

9. A method comprising:
at a computing platform comprising at least one processor, a communication interface, and memory:
configuring, based on a project management ruleset, a plurality of project silos corresponding to a first operation performed using a first set of information;
generating, based on the plurality of project silos, a plurality of project tags, wherein each project tag corresponds to a different project silo, of the plurality of project silos, wherein a given project tag comprises:
operation-level information corresponding to the first operation;
project-level information of the corresponding project silo; and
application-level information corresponding to at least one application included in the project silo;
executing at least one performance of the first operation using the first set of information;
generating, based on the application-level information of each project tag, a record of applications performing the first operation and using the first set of information;
receiving, from a first user device corresponding to a first user, a first request to access the record of applications, wherein the first request comprises:
authentication information corresponding to the first user; and
a first request tag, wherein the first request tag comprises at least one of:
a selection of requested operation-level information,
a selection of requested project-level information, and
a selection of requested application-level information;
determining, based on comparing the authentication information to a list of permissions associated with the record of applications, whether or not to grant the first user device access to the record of applications;
sending, based on determining to grant the first user device access to the record of applications, a first portion of the record of applications to the first user device, wherein the first portion of the record of applications corresponds to the first request tag;
inputting the record of applications into an operation optimization model, wherein inputting the record of applications into the operation optimization model causes the operation optimization model to output one or more project management rules; and
modifying, based on the one or more project management rules, the project management ruleset, wherein the modifying produces a modified project management ruleset.

10. The method of claim 9, further comprising:
receiving, from a second user device corresponding to a second user, a second request to access the record of applications, wherein the second request comprises:
application-level authentication information; and
a second request tag, wherein the second request tag comprises at least one of:
a selection of requested operation-level information,
a selection of requested project-level information, and
a selection of requested application-level information;
determining, based on comparing the application-level authentication information to a list of permissions associated with the record of applications, whether or not to grant the second user device access to the record of applications; and
sending, based on determining to grant the second user device access to the record of applications, a second portion of the record of applications to the second user device, wherein the second portion of the record of applications corresponds to the second request tag.

11. The method of claim 9, further comprising:
training, prior to inputting the record of applications and based on the project management ruleset, the operation optimization model to output the one or more project management rules based on input of a given record of applications; and
updating, based on the modified project management ruleset, the operation optimization model, wherein the updating causes the operation optimization model to perform one or more of:
output, based on input of a record of applications indicating at least two project silos include a same portion of application-level information, a rule for merging project silos,
output, based on input of a record of applications indicating at least two project silos include a same portion of application-level information, a rule for creating project silos, or
output, based on input of a record of applications indicating at least two project silos include a same portion of application-level information, a rule for removing project silos.

12. The method of claim 9, wherein a given project silo, of the plurality of project silos, comprises:
a project name identifier;
a project tag identifier;
a list of permissions, wherein the list of permissions limits access to the project silo;
a list of applications used to perform the first operation; and
at least a portion of the first set of information.

13. The method of claim 9, wherein the modifying the project management ruleset comprises at least one of:
adding a rule, of the one or more project management rules, for creating project silos;
adding a rule, of the one or more project management rules, for merging project silos;
adding a rule, of the one or more project management rules, for removing project silos;
merging a rule, of the one or more project management rules, with an existing rule; or
modifying, based on the one or more project management rules, access permissions for one or more project silos.

14. The method of claim 9, further comprising:
causing, based on determining not to grant the first user device access to the record of applications, the first user device to display a notification interface, wherein the notification interface indicates the first user is not authorized to access the record of applications; and
sending, based on the modifying, a project management update to the first user device, wherein the project management update comprises the modified project management ruleset.

15. One or more non-transitory computer-readable media storing instructions that, when executed by a computing platform comprising at least one processor, a communication interface, and memory, cause the computing platform to:
configure, based on a project management ruleset, a plurality of project silos corresponding to a first operation performed using a first set of information;
generate, based on the plurality of project silos, a plurality of project tags, wherein each project tag corresponds to a different project silo, of the plurality of project silos, wherein a given project tag comprises:
operation-level information corresponding to the first operation;
project-level information of the corresponding project silo; and
application-level information corresponding to at least one application included in the project silo;
execute at least one performance of the first operation using the first set of information;
generate, based on the application-level information of each project tag, a record of applications performing the first operation and using the first set of information;
receive, from a first user device corresponding to a first user, a first request to access the record of applications, wherein the first request comprises:
authentication information corresponding to the first user; and
a first request tag, wherein the first request tag comprises at least one of:
a selection of requested operation-level information,
a selection of requested project-level information, and
a selection of requested application-level information;
determine, based on comparing the authentication information to a list of permissions associated with the record of applications, whether or not to grant the first user device access to the record of applications;
send, based on determining to grant the first user device access to the record of applications, a first portion of the record of applications to the first user device, wherein the first portion of the record of applications corresponds to the first request tag;
input the record of applications into an operation optimization model, wherein inputting the record of applications into the operation optimization model causes the operation optimization model to output one or more project management rules; and
modify, based on the one or more project management rules, the project management ruleset, wherein the modifying produces a modified project management ruleset.

16. The one or more non-transitory computer-readable media of claim 15 storing additional instructions that, when executed by the computing platform, cause the computing platform to:
receive, from a second user device corresponding to a second user, a second request to access the record of applications, wherein the second request comprises:
application-level authentication information; and
a second request tag, wherein the second request tag comprises at least one of:
a selection of requested operation-level information,
a selection of requested project-level information, and
a selection of requested application-level information;
determine, based on comparing the application-level authentication information to a list of permissions associated with the record of applications, whether or not to grant the second user device access to the record of applications; and
send, based on determining to grant the second user device access to the record of applications, a second portion of the record of applications to the second user device, wherein the second portion of the record of applications corresponds to the second request tag.

17. The one or more non-transitory computer-readable media of claim 15 storing additional instructions that, when executed by the computing platform, cause the computing platform to:
train, prior to inputting the record of applications and based on the project management ruleset, the operation optimization model to output the one or more project management rules based on input of a given record of applications; and
update, based on the modified project management ruleset, the operation optimization model, wherein the updating causes the operation optimization model to perform one or more of:
output, based on input of a record of applications indicating at least two project silos include a same portion of application-level information, a rule for merging project silos,
output, based on input of a record of applications indicating at least two project silos include a same portion of application-level information, a rule for creating project silos, or
output, based on input of a record of applications indicating at least two project silos include a same portion of application-level information, a rule for removing project silos.

18. The one or more non-transitory computer-readable media of claim 15, wherein a given project silo, of the plurality of project silos, comprises:
a project name identifier;
a project tag identifier;
a list of permissions, wherein the list of permissions limits access to the project silo;
a list of applications used to perform the first operation; and
at least a portion of the first set of information.

19. The one or more non-transitory computer-readable media of claim 15, wherein the modifying the project management ruleset comprises at least one of:
adding a rule, of the one or more project management rules, for creating project silos;
adding a rule, of the one or more project management rules, for merging project silos;
adding a rule, of the one or more project management rules, for removing project silos;
merging a rule, of the one or more project management rules, with an existing rule; or
modifying, based on the one or more project management rules, access permissions for one or more project silos.

20. The one or more non-transitory computer-readable media of claim 15 storing additional instructions that, when executed by the computing platform, cause the computing platform to:
cause, based on determining not to grant the first user device access to the record of applications, the first user device to display a notification interface, wherein the notification interface indicates the first user is not authorized to access the record of applications; and
send, based on the modifying, a project management update to the first user device, wherein the project management update comprises the modified project management ruleset.
